(19) United States
(12) Patent Application Publication
(10) Pub. No.: US 2024/0110579 A1
(43) Pub. Date: Apr. 4, 2024

(54) COMPRESSOR

(71) Applicant: Cummins LTD, London (GB)

(72) Inventors: Robert Dewhirst, Yorkshire (GB); James Kelly, Yorkshire (GB)

(21) Appl. No.: 18/265,170

(22) PCT Filed: Dec. 3, 2021
(86) PCT No.: PCT/GB2021/053159

§ 371 Date: Jun. 2, 2023

(30) Foreign Application Priority Data
Dec. 4, 2020 (GB) 2019182.1

(51) Int. Cl. F04D 29/54; F04D 29/42

(52) U.S. Cl. CPC F04D 29/541; F04D 29/4233; F04D 29/4293; B33Y 50/02; F04D 29/4253

(57) ABSTRACT

A compressor cover for a turbomachine is disclosed. The compressor cover defines a central axis. The compressor cover comprises an inlet. The inlet is in fluid communication with a downstream outlet via a passage. The passage is at least partly defined between a first wall and a second wall of the compressor cover. One or more vanes extend across the passage, between the first and second walls. The one or more vanes are integrally formed with the first and second walls.

The present invention relates to a compressor cover, compressor assembly, compressor, turbomachine and associated methods.

Compressors receive fluid, such as air, via an inlet, and exhaust pressurised fluid via an outlet. Provided between the inlet and outlet is a compressor wheel, supported for rotation on a shaft. The compressor wheel does work on the fluid, by virtue of the shaft being driven, to increase the pressure of the fluid.

Compressor covers are known devices that generally surround the compressor wheel. Compressor covers may, for centrifugal compressors, also define a volute which interposes the inlet and outlet.

One such use of a compressor is in a turbocharger. Turbochargers are well known devices for supplying air to the intake of an internal combustion engine at pressures above atmospheric pressure (boost pressures). A conventional turbocharger comprises an exhaust gas driven turbine wheel mounted on a rotatable shaft within a turbine housing. Rotation of the turbine wheel rotates the compressor wheel mounted on the other end of the shaft within the compressor cover. The compressor wheel delivers compressed air to the intake manifold of the engine, thereby increasing engine power.

The turbocharger shaft is conventionally supported by journal and thrust bearings, including appropriate lubricating systems, located within a central bearing housing connected between the turbine and compressor.

Existing compressor covers, and surrounding components, contribute to reduced compressor efficiency, the build-up of a tolerance stack and undesirable thermomechanical fatigue performance.

There exists a need to provide an alternative compressor cover which overcomes one or more of the disadvantages of known compressor covers, whether mentioned in this document or otherwise.

According to a first aspect of the invention there is provided a compressor cover for a turbomachine, the compressor cover defining a central axis and comprising:
an inlet in fluid communication with a downstream outlet via a passage; wherein
the passage is at least partly defined between a first wall and a second wall of the compressor cover; and wherein
one or more vanes extend across the passage, between the first and second walls, the one or more vanes being integrally formed with the first and second walls.

Advantageously, the one or more vanes being integrally formed with the first and second walls, and extending between the first and second walls, means that there is no ‘free’, or exposed, end of the vane adjacent the first or second walls. In prior art arrangements, a free end of the vane can lead to a reduction in compressor efficiency. This is owing to a proportion of the flow passing between the free end of the vane and the adjacent surface. Such losses may be referred to as vane tip losses, or overtip leakage. The free end mentioned above refers to an end of the vane in a generally axial direction, and not to a leading or trailing edge (which, by definition, is an exposed edge of the vane). That is to say, if the vane was attached to the first and second sidewalls in a subsequent assembly step, it would be the free ends of the vane which engage the first and second walls. By way of a further advantage, because both ends of the vane are integral with the compressor cover, and leakage is therefore reduced or alleviated altogether, complex vane geometries can be utilised. Examples include non-parallel walled passages, curved vanes and/or 3D vane shapes. Such geometries were otherwise not possible, owing to the previous need to have a tip of the vane contact the compressor cover (so as to reduce overtip leakage).

The one or more vanes extending between the first and second walls is also beneficial in that the vanes do not contribute to a tolerance stack. Such a tolerance stack otherwise risks a gap being present between an exposed end of the vane and an adjacent surface (as described above). Alternatively, such a tolerance stack risks the free end of the one or more vanes contacting the adjacent surface, which can result in the vanes becoming damaged. A problem with prior art arrangements is maintaining contact between an inlet-side (or shroud side) of the compressor cover and a tip of a vane. By integrally forming the vane with the compressor cover, any issues relating to alignment, tolerance, and thermal distortion are reduced, if not alleviated altogether. Integrally forming the vane with the compressor cover also alleviates issues around how much force need be applied to maintain contact between the compressor cover and a tip of the vane, as is the case in prior art arrangements.

A further advantage of having the one or more vanes integrally formed with the first and second walls (of the compressor cover) is that no further constraint is required in order to rotationally constrain the one or more vanes with respect to the central axis. In prior art arrangements, and where the vanes are provided as part of a component which is separate to the compressor cover, it is required to rotationally constrain said component, relative to the compressor cover, using fasteners or similar. The rotational constraint is required because, in use, an aerodynamic torque is experienced by the component due to the passage of flow across the vanes. Rotational constraint may require discontinuities in surfaces that the fluid passes over. For example, fasteners may be used to secure the component to the compressor cover, resulting in a fastener head or other discontinuity protruding into the fluid flow path. There is also a risk that the fastener could become dislodged, due to vibration, and damage the compressor impeller. Said discontinuities can also contribute to efficiency losses by way of the formation of turbulent eddies and vortices, to name two examples, in the fluid flow path. Constraining the vanes provided on a separate component, as per prior art arrangements, also invariably increases the cost and complexity of the assembly. The presence of fasteners, on prior art arrangements, also limits the space available for placement of vanes (for example, it may not be possible for a vane to ‘overlap’ a fastener location). Removing the need for such fasteners, as per the present disclosure, is therefore advantageous in providing greater design freedom for placement/location of vanes.

Integrally forming the vanes also means that the use of dissimilar materials (owing to the omission of fasteners) can be avoided. This reduces the risk of corrosion and uneven thermal expansion, among other issues, that can result from the use of dissimilar materials.

Weight savings of up to around 20% may be achievable by integrally forming the one or more vanes with the first and second walls. This may be due to reducing the component count, and alleviating the need to align separate components relative to one another, and/or attach separate components to one another.

Finally, and for the reasons set out above, integrally forming the vanes improves the thermomechanical fatigue performance of the compressor cover and associated compressor assembly. This is at least in part because there is no longer a need to drive tips of the vanes into the compressor cover, to achieve contact between the vane and the compressor cover, which has historically been the case for prior art arrangements.

The compressor cover may be referred to as a compressor housing. The compressor cover generally surrounds the compressor wheel. The compressor cover may engage an adjacent support member. The support member may be a bearing housing or a seal plate. Alternatively, the second wall may form part of an integrally formed support member. The compressor cover may define a volute. The volute may be downstream of the passage. The volute may be generally toroidal. The volute may have a cross-sectional area which increases around the central axis. The cross-sectional area of the volute may increase linearly around the central axis.

The turbomachine may be a turbocharger. The compressor cover may therefore be for a turbocharger. The turbomachine may be a compressor, such as a fuel cell compressor.

The compressor cover may be said to extend around the central axis. The central axis may define an axis of rotation of a compressor impeller.

The inlet may be an aperture. The aperture may be generally circular. The inlet may be an axial inlet. That is to say, the inlet may be normal to the central axis. The inlet may be configured to engage an upstream pipe. Said pipe may comprise an inlet hose. The inlet may be in fluid communication with an intercooler.

The downstream outlet may be an aperture. The downstream outlet may be generally circular. The downstream outlet may be provided at a generally tangential position relative to the volute.

The passage may be generally annular. That is to say, the passage may take the form of a thickened circular disc with a smaller thickened circular disc of material having been removed therefrom, where the circles share a common axis. The passage may extend in a generally radial direction. That is to say, the passage may be generally radial. The passage may extend generally perpendicular to the central axis. The passage may be referred to as a diffuser, or a diffuser passage. The passage may otherwise be referred to as a channel or passageway.

The passage may be entirely defined between the first and the second wall. Alternatively, only a portion of the passage may be defined between the first wall and the second wall. The first wall and the second wall may be flat. Alternatively, the first and/or the second wall may be tapered and/or arcuate. The first wall and the second wall may be said to cooperate with one another to define the passage. The first and second walls may define axially outermost points of the passage. That is to say, the first and second walls may define an axial extent of the passage.

The one or more vanes may be described as diffuser vanes. The one or more vanes may be aerofoil shaped. That is to say, the one or more vanes may have a pressure side and a suction side. The pressure and suction side may both extend from a leading edge of the vane. The pressure and suction side may both terminate at a trailing edge of the vane. Each of the one or more vanes may be aerofoil shaped. The one or more vanes may be entirely arcuate. The one or more vanes may comprise linear portions. By virtue of the one or more vanes extending across the passage, the one or more vanes may be described as support spars. That is to say, the second wall may be attached to the first wall only by virtue of the one or more vanes. The one or more vanes may advantageously influence the fluid flow, which passes through the passage, to improve the efficiency of the compressor. This may be by way of imparting a swirl to the flow, or facilitating static pressure recovery. The one or more vanes may direct the fluid to more closely align the general flow direction with the volute. That is to say, the one or more vanes may direct the fluid flow towards the volute. This may be at an acute angle. The flow velocity may generally be reduced, reducing the overall pressure whilst increasing the static pressure of the flow (otherwise referred to as recovering static pressure from the flow). This advantageously means that less ‘work’ is required from the volute with respect to recovering static pressure from the flow.

An end of the vane which is proximate the first wall may be referred to as a shroud side of the vane. An end of the vane which is proximate the second wall may be referred to as a hub side of the vane. The second wall may form part of a vane backing plate.

The one or more vanes being integrally formed with the first and second walls is intended to mean that each of the first wall, the one or more vanes and the second wall is a monolithic structure. That is to say, each of these components is not connected to one another in a subsequent manufacturing process, but the joins between the components are present from the creation, or inception, of the components. The one or more vanes and the first and second walls may be described as being integral with one another. The one or more vanes, and the first and second walls, may be described as being a unitary body.

The one or more vanes may incorporate one or more undercuts. The one or more vanes may be angled in multiple directions i.e. have a complex geometry. The one or more vanes may incorporate geometric features which cannot be manufactured unless an additive manufacture process is used.

Where the passage is a generally annular passage which extends generally radially relative to the central axis, the one or more vanes may extend along a majority of a linear portion of the first and/or second walls. That is to say, the one or more vanes may extend radially along at least around 50% of linear portions of the first and/or second walls, and preferably at least around 70%. In particular, the one or more vanes may extend around 70% along the linear portion of the second wall. In some embodiments, the one or more vanes may extend radially along at least 75% of the linear portion of the first and/or second walls.

The vane may have a leading edge:trailing edge radius ratio of between around 1:1.4 and around 1.5:2. The leading edge:trailing edge radius ratio may be around 1.15:1.55. The leading edge:trailing edge radius ratio may be around 1:1.15. The leading edge:trailing edge radius ratio may be up to around 1:1.55, such as, for example, around 1:1.4.

The at least one vane may have a leading edge position equal to around 1.15× the compressor wheel outer diameter. The at least one vane may have a trailing edge position equal to around 1.55× the compressor wheel outer diameter.

The second wall may extend to a radial position which is adjacent, or proximate, a tip of the compressor wheel.

The compressor cover may diffuse and/or gather flow from a compressor wheel.

The compressor cover may be manufactured from stainless steel. The compressor cover may be manufactured from stainless steel grade 316. The compressor cover may be manufactured using an additive manufacturing process, such as binder-jetting.

The one or more vanes may comprise a plurality of vanes.

Where the one or more vanes comprises a plurality of vanes, the fluid passing through the passage may be more evenly influenced by the vanes. Incorporating a plurality of vanes is also advantageous in providing a more even distribution of mass around the central axis.

The plurality of vanes may comprise an odd number of vanes. Alternatively, the plurality of vanes may comprise an even number of vanes. The plurality of vanes may comprise between 9 and 17 vanes, for example. The number of vanes incorporated may depend upon a number of factors such as, but not limited to, compressor wheel size and desired compressor performance.

Where the one or more vanes comprises a plurality of vanes, each of the plurality of vanes may be substantially identical to one another. That is to say, each of the plurality of vanes may share the same geometry, but be provided at a different position around the central axis (for example). Specific examples of geometric variables include chord length, angle of attack, leading edge radial position, trailing edge radial position and vane thickness, to name but some geometric variables. Where the one or more vanes comprises a plurality of vanes, each of the plurality of vanes may be integrally formed with the first and second walls (i.e. such that there are no exposed tips, of any vane, present).

The plurality of vanes may be circumferentially distributed about the central axis.

Distributing the plurality of vanes circumferentially around the central axis is advantageous in more evenly influencing the fluid flowing through the passage. Furthermore, by circumferentially distributing the plurality of vanes, a supporting effect which the vanes may provide to the second wall is more robust around the central axis. That is to say, by providing a circumferential distribution as opposed to, for example, a non-circumferential distribution, the second wall may be more robustly connected to the first wall.

A circumferential distribution may be referred to as a circumferential array. Each of the plurality of vanes may be provided at a point on a circumference of a circle having a constant radius to the central axis. Drawing an arc through each of the leading edges of the plurality of vanes may therefore define a circle.

The circumferential distribution may also be advantageous in reducing the risk of distortion occurring between the first and second walls due to thermal expansion of the plurality of vanes or other surrounding components.

The plurality of vanes may be evenly circumferentially distributed, such that a distance, or circumferential offset, between adjacent vanes if the same for each of the vanes of the plurality of vanes.

Each of the one or more vanes may extend across the passage, between the first and second walls.

Having each one of the one or more vanes extend across the passage is advantageous in reducing efficiency losses attributable to an otherwise exposed free end of the vane.

The one or more vanes may be hollow.

The one or more vanes being hollow may otherwise be described as the one or more vanes having one or more cavities between the pressure and suction side of the vanes. For example, the one or more vanes may be defined by a thin wall loop which forms the pressure and suction sides of the vane. Within that thin wall loop a closed cavity may be defined. Alternatively, ribs may extend between inner surfaces of the pressure and suction sides of the vane, through the vane, to provide a robust structure to the vane. One or more cavities may be defined between the pressure side and/or ribs and/or suction side of the vane. Either option is advantageous in reducing the amount of material that would otherwise be used in a solid, and effectively filled, vane. There is an associated material saving, and so weight and cost saving, by incorporating the one or more cavities within the vanes. The cooling of the vanes may also be more uniform along or through the vane, which may reduce the risk of uneven thermal expansion along, or through, the vane.

Where the one or more vanes comprises one or more ribs, the ribs may be said to define a rib structure. The rib structure may be of the form of a truss or lattice.

The suction and pressure sides may generally conform to one another. Alternatively, the suction and pressure sides may not conform to one another. The vane geometry may be adjusted to reduce mass, for example.

The second wall may form part of a plate member.

The second wall forming part of a plate member is advantageous because the plate member is comparatively lightweight, whilst still defining the passage.

The plate member may refer to a body which has a comparatively low thickness when compared with other associated dimensions. That is to say, a surface area of the plate member when viewed normal to the central axis may be significantly larger than the associated thickness when the plate member is viewed in a cross-section along the central axis and through the plate member.

The plate member may be referred to as a vane backing plate, or a vane backplate.

A gap may be provided between a radially outer end of the plate member and an adjacent face of the volute wall. Put another way, a radially outer end of the plate member may be separate from, and detached from, an adjacent face of the volute wall. Said gap advantageously facilitates the thermal expansion of the vane and/or plate member without damaging the adjacent volute wall. The gap may be generally annular. The gap may be a radial offset. The gap may extend around the central axis. The gap may be of the order of between around 1 mm and around 5 mm in extent. The gap may otherwise be described as being provided between a free end of a volute wall and an outer end of the second wall and/or plate member.

A sealing feature, such as a lip, fluidic vortex seal, or other variety of seal or barrier may be incorporated to reduce the proportion of flow which flows through the gap.

The plate member may be annular.

The plate member being annular is advantageous in that the annular geometry generally conforms to an associated geometry of a support member to which the compressor cover is attachable.

The plate member being annular may otherwise be described as the plate member generally having the form of a thickened ring of material, and defining an aperture in the centre thereof.

The plate member may comprise a lip.

Advantageously, the lip is received in a corresponding recess, or groove, in the support member. By virtue of the lip being received in the recess, leakage of fluid between the plate member and the support member is greatly reduced. This reduces any losses in efficiency attributable to the flow of fluid through this (potential) leakage path.

Advantageously, by incorporating a lip, the entire surface of the second wall, which opposes the passage, may not need to have as tight a tolerance with respect to the support member. That is to say, by virtue of the incorporation of the lip, the importance of the position of the second wall relative to the support member may be reduced. This may be advantageous in that the tolerance requirement is also reduced, and the assembly can be created with parts having a comparatively greater tolerance (i.e. less precise dimensions).

The lip may extend away from the passage. That is to say, the lip may be a projection which projects away from the passage. The lip may be a generally circular projection which extends around the central axis. The lip may be annular.

In preferred arrangements, the lip is a continuous projection so as to seal the aforementioned (potential) leakage path around an entirety of the central axis. The lip may be described as a loop of material.

The lip is just one example of a possible sealing feature which may be provided. The sealing feature may be provided to reduce, or prevent, passage of fluid into a gap between a radially outer end of the plate member and a free end of the volute wall. Other examples of sealing features include fluidic vortex seals, and other seals/barriers.

The second wall may be uninterrupted save for the one or more vanes.

The second wall being uninterrupted save for the one or more vanes refers to the wall being generally smooth, with no discontinuities. Put another way, the second wall does not incorporate any apertures (e.g. for bolts) or other surface recesses or projections, save for the one or more vanes.

It may be a passage-facing surface of second wall which is uninterrupted save for the one or more vanes. The passage-facing surface of the second wall refers to a surface of the second wall which faces, or opposes, the first wall. Put another way, the passage-facing surface of the second wall refers to a surface of the second wall which defines the passage, and a surface across which fluid flowing through the passage will contact.

Providing an uninterrupted surface is advantageous because the risk of creating vortices and/or turbulent eddies in the fluid is reduced. More energy is therefore retained in the fluid. Furthermore, the flow is more uniform through the passage.

The first and second walls may be substantially parallel.

The first and second walls being substantially parallel is intended to mean that the first and second walls are offset from one another by an angle, taken relative to the central axis, of less than around 3 degrees. The first and/or second walls may extend radially relative to the central axis (i.e. perpendicular thereto), and the first and second walls may therefore be parallel (i.e. effectively no angular offset between the walls).

Advantageously the one or more vanes being integrally formed with first and second walls means that the first and/or second wall geometries can be varied to provide improved flow characteristics. For example, having arcuate first and second walls may be advantageous in influencing the flow to increase the efficiency of the compressor.

Tapered refers to the first and/or second walls being angularly offset from one another by at least 3 degrees. Arcuate refers to the first and/or second walls being nonlinear. That is to say, rather than the first and second walls extending linearly at a given angle relative to the central axis, the first and second walls extend in an arcuate manner.

Radially outer ends of the first and second walls may at least partly define a scroll.

The scroll advantageously increases the area available for the flow to traverse, thereby reducing the speed of the flow and increasing the static pressure. By having radially outer ends of the first and second walls at least partly define the scroll, a leakage path which may have otherwise been present between the passage and the scroll may be reduced or removed altogether.

The scroll may otherwise be described as a volute. The scroll may be described as having a generally snail-shell-shaped, or spiral, geometry. The scroll may be said to be generally toroidal.

The passage may be said to open out into the scroll.

The passage may be in fluid communication with the downstream outlet via the scroll.

The passage being in fluid communication with the downstream outlet via the scroll means that fluid which flows through the passage then flows through the scroll to the downstream outlet.

A gap may be provided between the radially outer end of the second wall and an adjacent face of a volute wall. The gap may be referred to as an expansion gap, or a thermal expansion gap. The volute wall may be referred to as a scroll wall. The gap may be a circumferentially extending gap. That is to say, the gap may extend around the central axis.

The compressor cover may be a centrifugal compressor cover.

The centrifugal compressor cover is advantageously usable with a centrifugal compressor.

Centrifugal compressor cover refers to a compressor cover having a generally axial inlet and a generally tangential outlet, and where fluid passes around the central axis as it flows from the inlet to the outlet.

The inlet may be an axial inlet.

The inlet being an axial inlet is intended to mean that the inlet generally aligns with, and is normal to, the central axis. An axial inlet provides a simple means of connecting the inlet to an upstream fluid component, such as a pipe.

The axial inlet may defines an inlet passageway sized to allow passage of a compressor wheel.

Advantageously, by having an inlet passageway sized to allow passage of a compressor wheel the compressor wheel can be inserted through the inlet and passed along the inlet passageway. This provides alternative options for the manufacture of the compressor cover, and for the order of assembly of a compressor incorporating the compressor cover.

Advantageously, being able to insert a compressor wheel through the inlet means that the compressor cover can be integrally formed with the support member. Examples of support members are a bearing housing and sealing plate. The sealing plate and bearing housing may: support a shaft for rotation about the central axis; and/or receive an oil slinger mounted to the shaft; and/or define a diffuser passage. Where the compressor cover is integrally formed with the support member, the aforementioned functionality can be provided by the compressor cover whilst being able to insert the compressor wheel through the inlet. This alleviates the need to be able to separate the compressor cover from the support member, in order to insert the compressor wheel, as is the case in prior art arrangements.

The inlet passageway may be a generally cylindrical body. The inlet passageway may be generally tubular. The inlet passageway may be described as pipe-like. The inlet passageway being sized to allow passage of a compressor wheel may mean that the inlet passageway has a larger internal diameter than an external diameter of the compressor wheel. The compressor wheel may be at least around 100 mm and optionally less than around 200 mm in diameter, for example. The compressor wheel can be inserted through the inlet passageway, or can traverse the inlet passageway, towards its final position. The passage of the compressor wheel may be substantially along the central axis. That is to say, the compressor wheel may be inserted through the inlet and then pass axially along the central axis for attachment to a shaft and/or receipt in a wheel cavity.

The inlet passageway may be configured to receive an insert.

Advantageously, the passageway being configured to receive an insert means that the compressor wheel can be received through the inlet, and the insert can then be received after the compressor wheel. The insert can thus provide, or define, a narrow geometry that the compressor wheel could otherwise not pass. The insert can be said to define a partial cover, or cap, over the compressor wheel.

The insert may define one or more arcuate surfaces, which may be generally frustoconical, which cooperate with and/or conform to outer surfaces of the compressor wheel (specifically blades thereof). The cooperation may reduce the leakage of flow between the compressor wheel and the insert, increasing the proportion of the flow which passes across the compressor wheel and is therefore energised by the compressor wheel.

The insert may attach to the inlet passageway, or be mounted within the inlet passageway. The insert may be attached by a mechanical fastening means, such as a bolt. Alternatively, the insert may incorporate an integral fastening means, such as a screw thread, which may be used to secure the insert within the inlet passageway. Other means of securing the insert, such as welds or piston rings, may alternatively be used to secure the insert within the inlet passageway. The insert may be press-fitted into the inlet passageway.

The insert may directly engage the inlet passageway i.e. surface to surface contact. Alternatively, the insert may indirectly engage the inlet passageway i.e. there may be one or more interposing components.

The insert may be removably secured to the inlet passageway, such that the insert can be subsequently removed. Alternatively, the insert may be permanently secured to the inlet passageway (i.e. such that the insert cannot be detached from the inlet passageway without damaging either component).

The insert may be a ring of material. The insert may described as a loop. The insert may define an aperture in a centre thereof. An outer portion, or outermost portion, of the insert may be a connection portion which secures the insert to the inlet passageway. The insert may have a shape which generally corresponds with a torus i.e. the insert may be generally toroidal.

According to a second aspect of the invention there is provided a compressor assembly comprising a compressor cover according to the first aspect of the invention, and further comprising:
an insert mounted within the inlet passageway; wherein
the second wall of the compressor cover forms part of a support member; and wherein
the support member and insert cooperate to define a wheel cavity configured to receive a compressor wheel.

Advantageously, the component count is reduced owing to the support member and compressor cover being integrally formed with one another. Similarly, leakage paths which may have otherwise existed between the compressor cover and the support member (when separate components) are eliminated.

The compressor assembly can otherwise be described as a collection of housing components. Where the compressor assembly is arranged with a shaft and compressor wheel, the arrangement may be said to define a compressor.

The wheel cavity refers to a cavity which generally corresponds to a shape of an outer geometry of the compressor wheel. That is to say, if the compressor wheel is placed in the compressor cavity, then almost all of the flow passes across the compressor wheel and minimal flow passes between outer tips of blades of the compressor wheel and the insert.

The compressor cover forming part of a support member is intended to mean that the compressor cover and support member are integral with one another. That is to say, components form a single body.

The support member may be configured to support rotation of a shaft about the central axis.

The compressor cover may further comprise a connection portion configured to engage a corresponding connection portion of a support member.

The connection portion may be a flange, or other abutment means, which is used to engage a corresponding abutment means. In preferred arrangements each of the compressor cover and support member comprise a flange. The flanges may abut one another to align the two components.

Fasteners, such as bolts, may be used to secure the two flanges together. Such fasteners may pass through the flanges, or alternatively pass through other components. Alternatively, band clamps may be used to surround the flanges and, upon tensioning, secure the flanges to one another.

The support member may be configured to support rotation of a shaft about the central axis.

According to a third aspect of the invention there is provided a compressor comprising the compressor cover according to the first aspect of the invention.

The compressor may comprise a compressor wheel. The compressor may comprise a shaft. The compressor wheel may be secured to the shaft.

Advantageously, a compressor incorporating the compressor cover has improved performance over prior art arrangements.

According to a fourth aspect of the invention there is provided a turbomachine comprising the compressor assembly according to the second aspect of the invention or the compressor according to the first aspect of the invention.

The turbomachine may be a turbocharger. The turbomachine may be a fuel cell compressor. The turbocharger may be a fixed geometry turbocharger. The turbocharger may be a variable geometry turbocharger.

The turbocharger may form part of an engine arrangement. The engine arrangement may be part of a vehicle, such as an automobile. The engine arrangement may have a static application, such as in a pump arrangement or in a generator.

The turbocharger may comprise a turbine which is connected, directly or indirectly, to the compressor. The turbine may comprise a turbine wheel, the turbine wheel being supported on the same shaft as the compressor wheel. An exhaust gas flow may be used to drive the turbine wheel so as to drive rotation of the compressor wheel.

The compressor may be secured to the turbine via the support member. The support member may be a bearing housing. The support member may be a seal plate. The seal plate may be secured to the bearing housing.

The downstream outlet of the compressor may be in fluid communication with an inlet manifold of cylinders of an engine. The compressor may be used to provide a boost pressure to the engine. An engine comprising the turbocharger may provide improved performance over an engine without a turbocharger, owing to exhaust gas exhausted from the cylinders being used to drive the turbine wheel and so compressor wheel. In other words, otherwise wasted energy in the exhaust flow is used to pressurise air which is used in the combustion cycle.

According to a fifth aspect of the invention there is provided a method of manufacturing a compressor cover using an additive manufacture method.

The compressor cover may be according to any of the above aspects of the invention.

Using an additive manufacture method to manufacture the compressor cover advantageously means that the complex geometry can be readily manufactured. Using an additive manufacture method provides for improved flexibility of component/feature design and can produce a component with a comparatively reduced weight, and reduced wastage of material, when compared to other methods of manufacture. The additive manufacture method may be a 3D printing method. The additive manufacture method may be binder-jetting.

The compressor cover may be manufactured using stainless steel. The compressor cover may be manufactured using stainless steel grade 316.

According to a further aspect of the invention there is provided a compressor cover manufactured by an additive manufacture process.

According to a sixth aspect of the invention there is provided a method of assembling a compressor, the compressor comprising:
a compressor cover defining a central axis and comprising an inlet in fluid communication with a downstream outlet, the compressor cover being integrally formed with a support member;
a shaft which extends through the support member; and a compressor wheel;
the method comprising the steps of:
(i) inserting the compressor wheel through the inlet and along an inlet passageway;
(ii) securing the compressor wheel to the shaft; and
(iii) inserting the insert through the inlet, and along the inlet passageway, and mounting the insert within the inlet passageway to define a wheel cavity.

Advantageously the method means that a compressor cover can be integrally formed with the support member whilst still providing a wheel cavity that closely adheres to, or conforms to, an external geometry of the compressor wheel. Integrally forming the compressor wheel and support member is advantageous for reasons of removing leakage paths which may otherwise exist between the components, improving the thermomechanical fatigue performance of the compressor and reducing the component count. Removal of the joint between the compressor cover and support member is also advantageous in more effectively containing debris in the event of a burst rotor. This may be because joints can typically be a relatively weak link in containing debris in a rotor burst scenario.

The compressor wheel may be inserted in a substantially axial direction. The insert may be inserted in a substantially axial direction.

Securing the compressor wheel to the shaft may comprise threading the compressor wheel to the shaft. Securing the compressor wheel to the shaft may comprise passing the compressor wheel over the shaft and securing the compressor wheel to the shaft with a nut. The nut may be threadably engaged to an end of the shaft. The compressor wheel may be secured to the shaft by alternative securing means, such as welding or a threaded engagement.

The shaft may be indirectly supported by the support member. For example, one or more bearings may be secured within the support member, and the bearings in contact with the shaft. The bearings may support the shaft for rotation about the central axis.

Mounting the insert within the inlet passageway may be by a number of different means. A fastener may be used to attach the insert within to the inlet passageway. Alternatively, the insert may be welded to, or threadably engaged with, the inlet passageway.

In step (ii) the shaft may be supported by the support member.

The insert may at least circumferentially surround the compressor wheel. That is to say, the insert may conform to the compressor wheel at least around the central axis. An axial end of the compressor wheel, proximate the inlet, may be exposed (and not surrounded). That is to say, the insert may comprise a bore. The bore may be generally axial. In use, fluid may flow through the bore before reaching the compressor wheel.

The inlet may be in fluid communication with the downstream outlet via a passage. The passage may be at least partly defined between a first wall and a second wall. One or more vanes may extend across the passage, between the first and second walls. The one or more vanes may be integrally formed with the first and second walls.

The support member, which is integrally formed with the compressor cover, may provide the functionality of a seal plate or a bearing housing. The method may be said to refer to a method of assembling a turbocharger.

Before step (i), the shaft may be inserted through the support member. After the shaft has been inserted in position, a collar may be secured to the shaft. A thrust bearing may then be incorporated, in engagement with the collar. Lastly, an oil slinger may be secured to the shaft. This may complete an assembly process for assembling the shaft such that it is supported (for rotation) by the support member. It will be appreciated that the shaft may be axially constrained by the support member.

According to a seventh aspect of the invention there is provided a computer program comprising computer executable instructions that, when executed by a processor, cause the processor to control an additive manufacturing apparatus to manufacture a compressor cover.

The compressor cover may be in accordance with the above aspects of the invention, incorporating any optional features provided in connection with the above aspects.

According to an eighth aspect of the invention, there is provided a method of manufacturing a compressor cover via additive manufacturing, the method comprising:
obtaining an electronic file representing a geometry of a product wherein the product is a compressor cover; and
controlling an additive manufacturing apparatus to manufacture, over one or more additive manufacturing steps, the product according to the geometry specified in the electronic file.

The compressor cover may be in accordance with the above aspects of the invention, incorporating any optional features provided in connection with the above aspects.

The optional and/or preferred features for each aspect of the invention set out herein are also applicable to any other aspects of the invention.

Specific embodiments of the present invention will now be described, by way of example only, with reference to the accompanying drawings in which:

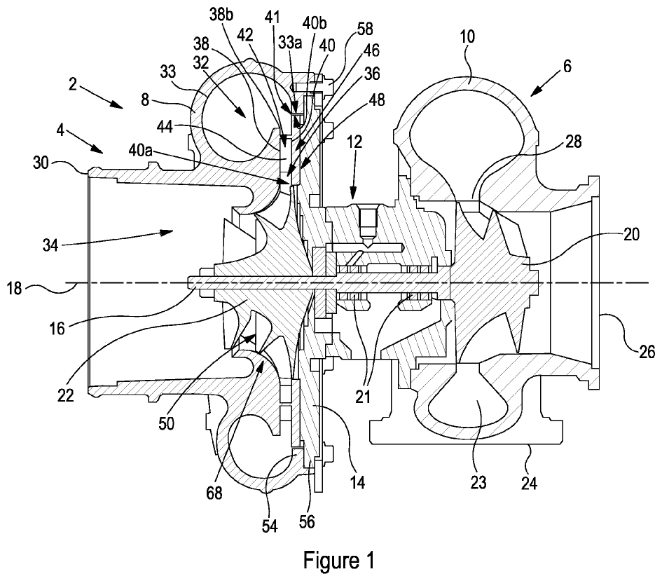

FIG. 1 is a cross section view of a turbocharger incorporating a compressor cover in accordance with an embodiment of the invention;

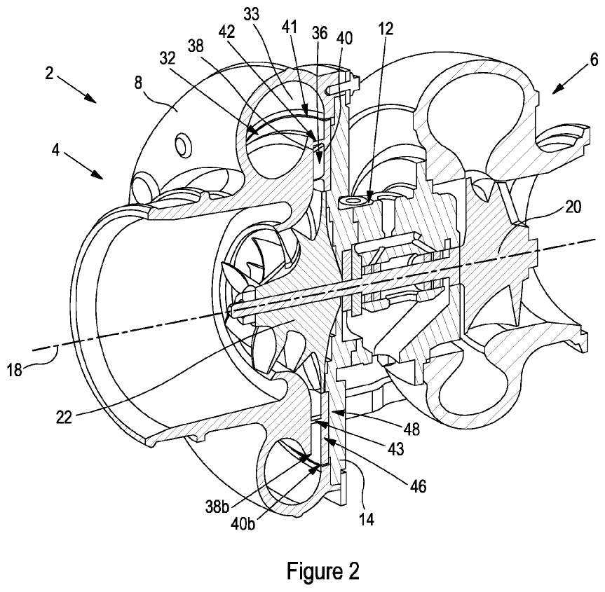

FIG. 2 is a perspective cross section view of the turbocharger of FIG. 1;

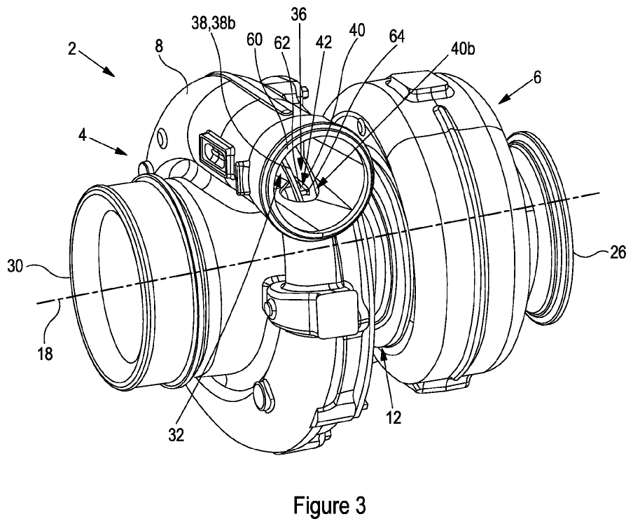

FIG. 3 is a perspective view of the turbocharger of FIGS. 1 and 2;

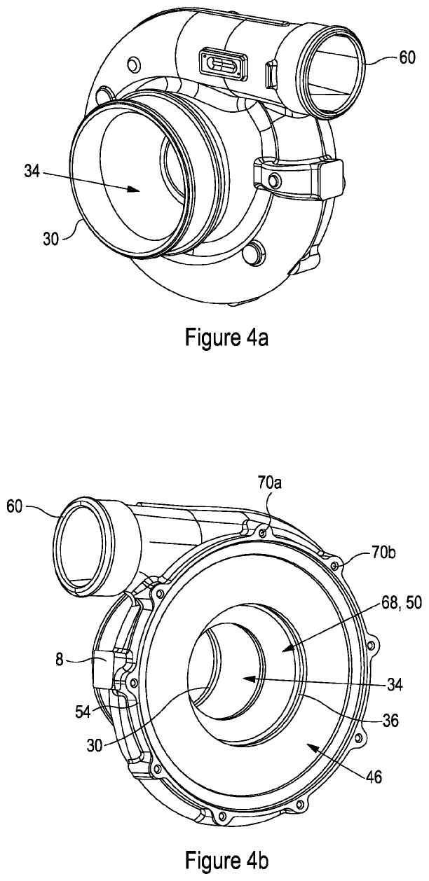

FIG. 4a is a perspective view of a compressor cover, and other components, of the turbocharger of FIGS. 1-3 in isolation;

FIG. 4b is an alternative perspective view of the compressor cover, and other components, shown in FIG. 4a

FIG. 4c is a side view of the compressor cover, and other components, shown in FIGS. 4a-c;

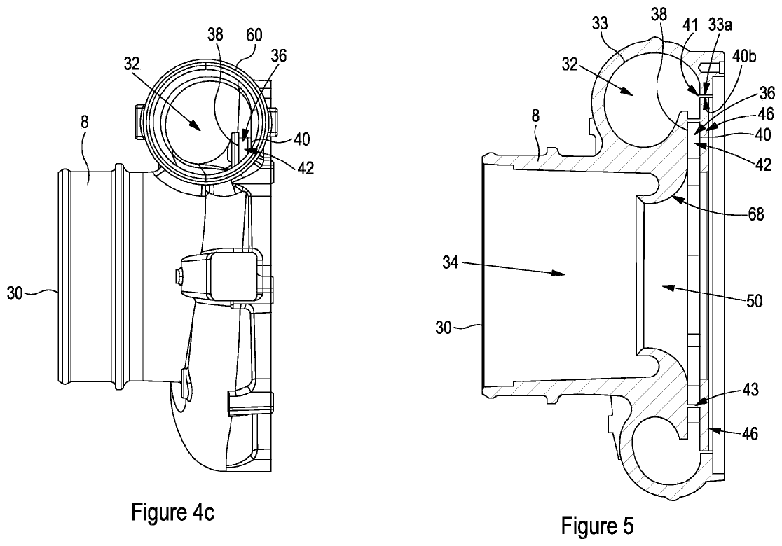

FIG. 5 is a side cross section view of the compressor cover, and other components, shown in FIGS. 4a-c;

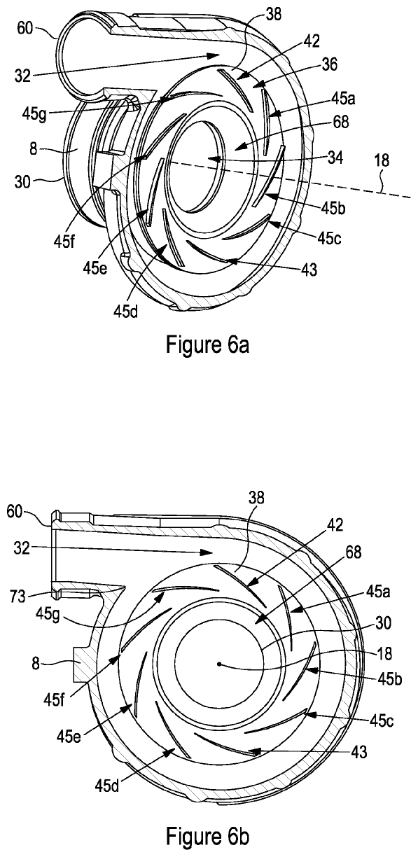

FIG. 6a is a perspective cross section view of the compressor cover of the preceding Figures;

FIG. 6b is an end-on cross section view of the compressor cover of FIG. 6a;

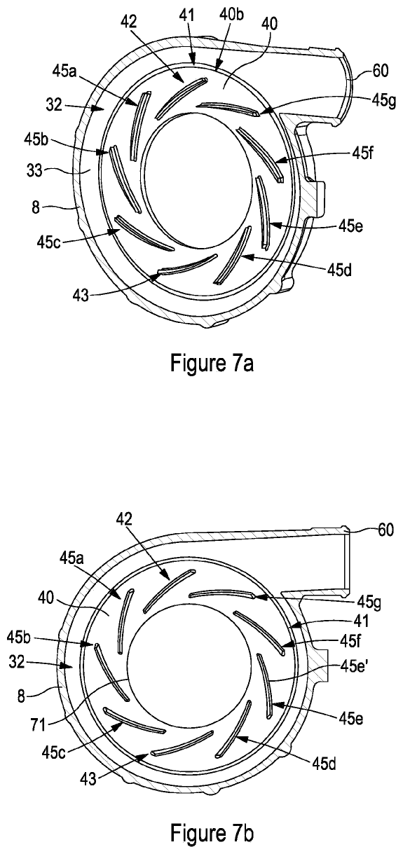

FIG. 7a is an alternative perspective cross section view of the compressor cover of FIGS. 6a and 6b;

FIG. 7b is an end-on cross section view of the compressor cover of FIG. 7a; and

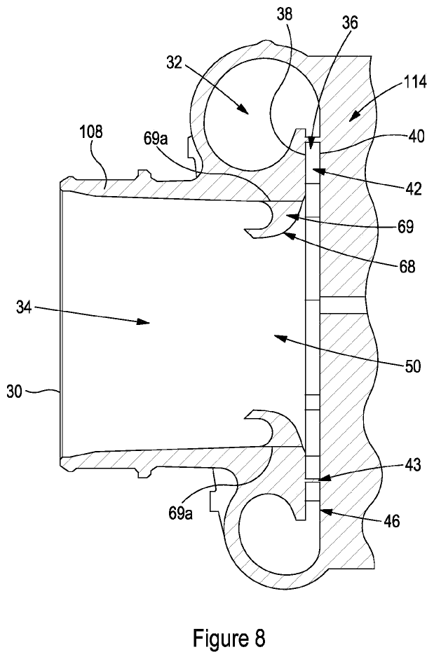

FIG. 8 is a cross section side view of a compressor cover, and other components, according to another embodiment.

FIG. 1 is a turbocharger 2 in accordance with the invention.

The turbocharger 2 comprises a compressor 4 and a turbine 6. The compressor 4 comprises a compressor cover 8. The compressor cover 8 is a particular focus of the present application, for reasons which will be explained hereinbelow. The turbine 6 comprises a turbine housing 10, which may be referred to as a turbine cover.

The compressor 4 is connected to the turbine 6 via a central bearing housing 12. In the illustrated embodiment, the compressor 4 is directly connected to a support member 14, which is of the form of a seal plate (which may otherwise be referred to as a diffuser plate). The seal plate is directly connected to the bearing housing 12. However, in other embodiments the bearing housing may constitute the support member, and the compressor may directly connect to the bearing housing. In further alternative embodiments, the compressor cover according to the invention may be integrally formed with the support member (this will be described in more detail below).

A shaft 16 extends from the turbine 6 to the compressor 4 through the bearing housing 12 and support member 14. A turbine wheel 20 is mounted on one end of the shaft 16 for rotation within the turbine housing 10. A compressor wheel 22 is mounted on the other end of the shaft 16 for rotation within the compressor cover 8. The shaft 16 rotates about central axis 18 on bearing assemblies located in the bearing housing 12 and/or support member 14, and generally labelled 21. The bearing assemblies are illustrated schematically in the Figures.

The turbine housing 10 defines an inlet volute 23 to which gas from an internal combustion engine (not shown) is delivered. The exhaust gas enters the turbine 6, specifically inlet volute 23, via a generally tangential turbine inlet 24. The exhaust gas flows from the turbine inlet 24, through inlet volute 23 to an axial outlet 26 via an annular opening 28 and across the turbine wheel 20. The annular opening 28 is defined between opposing walls of the turbine housing 10. The annular opening 28 may be referred to as a nozzle, owing to it defining a throat, or constriction, between the volute 23 and the turbine wheel 20. The annular opening 28 may otherwise be referred to as an annular passageway.

A wastegate (not visible in FIG. 1) may be used to divert a proportion of the exhaust gas around the turbine wheel 20 (i.e. such that the exhaust gas is not expanded across the turbine wheel 20). This is one way of controlling the speed of the turbine wheel 20.

Alternatively, a nozzle ring and shroud may define the annular opening, and be axially moveable relative to one another to adjust the extent to which the annular opening is open. This is another means of controlling the turbine wheel speed.

The speed of the turbine wheel 20, and so speed of the compressor wheel 22, is dependent, at least in part, upon the velocity of the gas passing through the annular opening 28. Gas flowing from the inlet volute 23 to the outlet 26 passes over, and is expanded across, the turbine wheel 20 and, as a result, torque is applied to the shaft 16 to drive the compressor wheel 22. Rotation of the compressor wheel 22 within the compressor cover 8 pressurises ambient air present in an axial inlet 30 and delivers the pressurised air to a downstream outlet (not visible in FIG. 1) via a volute 32. The pressurised air is then fed to an internal combustion engine (not shown). Where the compressor does not form part of a turbocharger it will be appreciated that the pressurised air may not be fed to an internal combustion engine, and may instead be directed to another component. The volute 32 may otherwise be described as a scroll, and is generally toroidal in shape.

As mentioned above, the compressor cover 8 is a particular focus of the present application. When fluid, such as air, enters the compressor 4 via the inlet 30, it first passes through an inlet passageway, denoted 34 in FIG. 1. The fluid then reaches the compressor wheel 22, passing over blades of the compressor wheel 22. Whilst the compressor wheel 22 rotates, work is done on the fluid. The fluid then passes through a passage 36. The passage 36 is a generally radial annular passage. The passage 36 interconnects the inlet passageway 34, and so inlet 30, with the volute 32 (and so downstream outlet). More detail regarding the passage 36 will be provided below.

After passing generally radially along the passage 36, the fluid enters the volute 32. The volute 32 has a cross-sectional area which increases, generally linearly, around the central axis 18, so as to recover pressure from the flow (this is shown in FIGS. 6a-7b). The pressurised fluid then exits the compressor 4 via the downstream outlet (again, not shown in FIG. 1, but labelled 60 in FIGS. 6a-7b).

Turning to the passage 36, the passage 36 is defined, at least in part, by a first wall 38 and a second wall 40. The first and second walls 38, 40 are generally annular in that they extend around the central axis 18. The passage 36, as mentioned above, extends in a generally radial direction relative to the central axis 18. That is to say, in the illustrated embodiment, the passage 36 extends generally perpendicularly to the central axis 18. In other embodiments, the passage may extend at any one of a range of different angles relative to the central axis 18. The passage 36 may be described as a diffuser, or a diffuser passage. This may be because in the passage 36 the velocity of the fluid is reduced so as to generally decrease the total pressure of the flow whilst increasing the static pressure of the flow (otherwise known as recovering static pressure in the flow). In other arrangements the passage may generally diverge moving radially outwardly of the central axis.

A plurality of vanes, one of which is labelled 42 in FIG. 1, extend across the passage 36. That is to say, the plurality of vanes extend between the first and second walls 38, 40. Each of the plurality of vanes have the shape of an aerofoil and therefore have a pressure side and a suction side. The pressure side is generally proximate the compressor wheel 22. Put another way, the pressure side is the side of the vane 42 which is closest to the central axis 18. The suction side is generally distal compressor wheel 22. As shown in FIG. 1, the pressure side of the vane 42 is labelled 44. The plurality of vanes are also illustrated in FIGS. 6a-7b, which will be described later in this document.

A number of advantages arise from having the one or more vanes integrally formed with the first and second walls 38, 40. Firstly, there is no free, or exposed, end of the vane proximate either of the first and second walls. That is to say, there is no gap between an axial tip of the vane and the adjacent first or second wall 38, 40. A gap between the vane end and the adjacent first or second wall 38, 40 has been found to reduce the overall efficiency of the compressor, owing to tip losses. Furthermore, problems due to dissimilar materials contacting one another, tolerance stacks, different thermal expansion rates and a high component number are reduced or avoided altogether by virtue of having the vanes integrally formed with the first and second walls. Another advantage is that, compared to prior art arrangements, thermal distortion, which can lead to vane tip lift, is generally reduced or alleviated.

As shown in FIG. 1, the second wall 40 forms part of a plate member 46. Plate member 46 is generally annular in shape. The plate member 46 has an associated thickness, which, in some examples, may be around 6 mm. The thickness may be between around 1 mm and around 10 mm. A radially inner end 40a of the second wall 40, and so plate member 46, is proximate a radially outer tip of the compressor wheel 22. A radially outer end 40b of the second wall 40, and so plate member 46, is distal the compressor wheel 22. Radially outer ends 38b, 40b of the first and second walls 38, 40 define, at least in part, the volute 32. The volute 32 is also defined by a volute wall 33. The volute wall 33 extends between radially outer ends 38b, 40b of the first and second walls 38, 40. The radially outer end of the second wall 40 is effectively the radially outer end 40b of the plate member 46 in the illustrated embodiment. The radially outer end of the first wall 38 is labelled 38b. The radially outer end 40b of the second wall 40 may be located at a radial position equal to around 1.6× the compressor wheel outer diameter.

In the illustrated embodiment, a gap 41 is present between the radially outer end 40b of the plate member 46 and an adjacent face 33a of the volute wall 33. The gap 41 is advantageous in facilitating movement (e.g. expansion) between the volute wall 33 and the plate member 46. Owing to the vanes 42 being relatively thin (and therefore having a relatively low thermal inertia), they increase in temperature more quickly than surrounding components in use. The vanes 42 are therefore more susceptible to thermal expansion in use. The gap 41 provides a clearance which allows the vanes 42 and/or plate member 46 to expand, or distort, in use, without risking damage to the adjacent face 33a of the volute wall 33 and/or the vanes 42 and/or the plate member 46. In the illustrated embodiment the gap 41 is effectively a radial offset, but in other embodiments it will be appreciated that the gap may extend in a different direction (depending upon the interface between the plate member 46 and volute wall 33). The gap 41 may otherwise be described as being defined between the radially outer end 40b of the second wall 40 and the free end of the volute wall 33. The gap 41 may be said to be provided between an outer end 40b of the plate member 46 and/or second wall 40, and a free end and/or adjacent face 33a of the volute wall 33. The gap 41 may be provided anywhere downstream of, or radially outwardly of, a trailing edge of the vane 42.

The gap 41 interrupts what would otherwise be a closed ‘loop’ of material between the radially outer end 40b of the plate member 46, the vane 42, the radially outer end 38b of the first wall 38 and the volute wall 33.

The gap 41 is generally annular, and extends around the central axis 31. The plate member 46 is therefore, in the illustrated embodiment, solely supported by the vanes 42.

The gap 41 may otherwise be described as the radially outer end 40b of the plate member 46 being separated from the adjacent face 33a, or end of, the volute wall 33. Put another way, the volute wall 33 has a free end (generally indicated by numeral 33a). The free end of the volute wall 33 is detached from (i.e. is not connected to) the plate member 46.

Also as indicated in FIG. 1, the second wall 40 is proud of the adjacent downstream surface of the volute wall 33. Put another way, the end of the volute wall 33, adjacent second wall 40, is recessed relative to the second wall 40. In use, fluid passes through the passage 36, along the second wall 40 and cascades onto the volute wall 33 (past the free end, generally indicated 33a, thereof).

Although not illustrated in FIG. 1, one or more sealing features may be incorporated to reduce the proportion of flow which enters the gap 41. Such flow entering the gap 41 risks the flow recirculating behind the plate member 46, which is undesirable for reasons of reduced compressor efficiency. Sealing features include, for example, a fluidic vortex seal, sealing plate, lip or other variety of seal or barrier.

In use, and as indicated in FIG. 1, the plate member 46 is received in, or by, a corresponding recess 48 in the support member 14. The combination of the support member 14 and compressor cover 8 define a wheel cavity 50 which is configured to receive the compressor wheel 22. The wheel cavity 50 conforms to an outer geometry of the compressor wheel 22 such that a gap between outer edges of blades of the compressor wheel 22 and an adjacent wall surface (e.g. arcuate wall surface 68) is reduced whilst still allowing the compressor wheel 22 to rotate freely without fouling.

In the illustrated embodiment, the compressor cover 8 is attached to the support member 14 after the compressor wheel 22 is placed on, and secured to, the shaft 16. Such an installation order ensures that a gap between outer edges of the blades of the compressor wheel 22 and the arcuate wall surface 68 is relatively low. This is advantageous in ensuring that fluid, which enters the inlet 30, passes across the compressor wheel 22, and therefore have work done on it to increase the energy of the flow. The aforementioned gap (between outer edges of the blades of the compressor wheel 22 and the arcuate wall surface 68) represents an undesirable leakage path across the compressor wheel 22.

The geometry of the wheel cavity 50 is such that the compressor wheel 22 cannot be inserted from the inlet 30 end of the compressor cover 8. This is owing to the outer diameter of the compressor wheel 22 exceeding an internal diameter of the wheel cavity 50 (which corresponds with an internal diameter of the narrowest point of the arcuate wall surface 68).

In FIG. 1 the compressor cover 8 engages the support member 14 by way of a flange 54. The flange 54 forms part of the compressor cover 8, and may be referred to as a connection portion. As indicated in FIG. 1, a corresponding flange 56, which may also be referred to as a connection portion, forms part of a support member 14. By virtue of abutment of the flanges 54, 56, the compressor cover 8 is located with respect to the support member 14. As shown at the top of FIG. 1, one or more fasteners 58 can then be used to secure the compressor cover 8 to the support member 14.

As mentioned above, in alternative embodiments the support member 14 may not be a separate component that engages the bearing housing 12. In other arrangements, the bearing housing constitutes the support member and the compressor cover 8 connects directly to the bearing housing. In such arrangements, the compressor cover may directly connect to the bearing housing by abutment of connection portions associated with each component. Flanges may be used in the alternative embodiments mentioned above. In further alternatives, the compressor cover may be integrally formed with the support member. In such alternatives, there is no need to attach the compressor cover to the support member (owing to the parts being integrally formed with one another).

Advantageously, the invention also allows for the relative positions of the radially outer ends 38b, 40b of the first and second walls 38, 40 to be adjusted. Specifically, the geometry of the volute 32 can be more readily varied. This is owing to manufacturing the compressor cover 8 using an additive manufacture method, rather than sandcasting (for example) which may require the support, and removal, of a core within and from the volute 32 (and between the radially outer ends 38, 40b). Manufacturing the compressor cover using casting may necessitate a sand core being supported within the passage 36 and the volute 33, which may not be possible (owing to the fact that the plate member 46 effectively ‘closes off’ the volute 32). It may therefore not be possible to access the volute 32, to locate/remove a core. The support and removal of the core may require there be a certain opening geometry (i.e. not an undercut) between the radially outer ends 38b, 40b of the first and second walls 38, 40. Such constraints are not present when the compressor cover 8 is manufactured using an additive manufacture method. One specific example of a geometry change, attainable using additive manufacture, is that a radial gap between radially outer ends 38b, 40b of the first and second walls 38, 40 respectively may not be required. For example, the radially outer end 40b could be moved further towards the central axis 18, creating an effective undercut geometry which would be difficult, if not impossible, to manufacture using a casting method. Another benefit stemming from additive manufacture of the compressor cover is that draft angles, required for prior art casting methods, are no longer required.

Turning to FIG. 2, a perspective cross section view of the turbocharger 2 shown in FIG. 1 is provided.

FIG. 2 illustrates how the vane 42 extends across the passage 36, between the first and second walls 38, 40. The gap 41, provided between a free end of the volute wall 33 and the second wall 40, is also labelled. A further, separate vane is shown at the lower part of FIG. 2. Said vane is labelled 43 and extends across the same passage 36 but at a different angular position, about the central axis 18, relative to the first vane 42. Detail regarding the arrangement of vanes will be provided in connection with FIGS. 6a-7b.

Returning to FIG. 2, the plate member 46, of which the second wall 40 forms part, is illustrated as being annular in shape. The receipt of the plate member 46 in the recess 48 (in the support member 14) is also illustrated. FIG. 2 illustrates how the passage 36 opens out into volute 32. Also shown in the lower part of FIG. 2, radially outer ends 38b, 40b of the first and second walls 38, 40 at least partly define the volute 32.

In some embodiments, although not illustrated in FIG. 2, the plate member may comprise a lip. The lip may project generally axially from a side of the plate member which is distal the passage. That is to say, the lip may project from the plate member in a direction towards the support member. The support member may incorporate a recess configured to receive the lip. This may be advantageous in reducing leakage between the plate member and the support member. The lip may be generally annular. The lip is an example of a sealing feature, as mentioned above, which may be incorporated to reduce flow leakage through the gap 41.

Returning to FIG. 2, the first and second walls 38, 40 are generally parallel and extend radially in the illustrated embodiment, but in other embodiments this may not be the case. The first and/or second walls may be tapered towards or away from one another. The first and/or second walls may also be arcuate. That is to say, the first and/or second walls may not extend in a straight line at a given angle to the central axis. The first and second walls may diverge (e.g. the cross-sectional area of the passage may generally increase moving radially outwardly from the central axis).

FIG. 3 is a perspective view of the turbocharger 2 as shown in FIGS. 1 and 2.

FIG. 3 shows a downstream outlet 60 of the compressor 4, specifically the compressor cover 8 thereof. The downstream outlet 60 is defined by the compressor cover 8. The increasing cross-sectional area of the volute 32, with angular position about the central axis 18, is also more readily visible in FIG. 3.

Due to the angle of the perspective view of FIG. 3, an interior of part of the volute 32 is visible through the outlet 60. A portion of the passage 36 which opens out into the volute 32 is also visible in FIG. 3. FIG. 3 also illustrates how the vane 42 extends across the passage 36, in an axial direction, between the first and second walls 38, 40. FIG. 3 also illustrates how the radially outer end 38b of the first wall 38 defines a rim as it extends around the central axis 18.

It will be appreciated that fluid, such as air, which enters the compressor 4 via the inlet 30 thus passes through the passage 36, being influenced by the vane 42 (among others) before entering the volute 32 and exiting the compressor 4 via the outlet 60.

Looking through the downstream outlet 60, specifically at the vane 42, a suction side 62 of the vane 42 is visible. That is to say, a side of the vane 42 which is generally distal the central axis 18 is visible. A trailing edge 64 of the vane 42 is also visible. From FIG. 3 it will be appreciated that a radial clearance may exist between a radially outer end 38b, 40b of the first and second walls 38, 40 respectively and a radially outer point of the vane 42. That is to say, a radially outer point of the vane 42 (which may be one of a plurality of vanes) may not extend up to a radially outer end 38b, 40b of the first and second walls 38, 40 respectively. The vanes may be described as being radially inboard of the radially outer end 38b of the first wall 38. The vanes may be described as being radially inboard of the radially outer end 40b of the second wall 40. However, in other embodiments there may be no such clearance and, instead, the trailing edge of the vanes may extend up to a radially outer end of the first and/or second walls.

As will be appreciated from FIG. 3 (at least with respect to the second wall 40), axial ends of the vane 42 (of the plurality of vanes) are integrally formed with each of the first and second walls 38, 40. As such, there is no free end, or exposed end, of the vane and so losses due to flow passing between an exposed end of the vane and an adjacent wall are reduced or avoided altogether. Fillets i.e. rounded edges may be incorporated between the vane 42 and the first and/or second walls 38, 40, and specifically at edges thereof.

FIG. 4a is a perspective view of the compressor cover 8, and other components, in isolation. The other components are provided in the inlet 30 of the compressor cover 8. For completeness, the perspective view of FIG. 4a is generally an end-on view taken in a direction looking towards a bearing housing when the compressor cover 8 is in situ.

FIG. 4b is a further perspective view of the compressor cover 8 and other components. The view of FIG. 4b is generally an end-on view taken from a bearing housing side when the compressor cover 8 is in situ.

In FIG. 4b it can be seen that the inlet 30 opens out into the generally tubular inlet passageway 34. The generally arcuate wall surface 68 is provided adjacent the inlet passageway 34. The arcuate wall surface 68 defines, at least in part, the wheel cavity 50 in which a compressor wheel is received. The wall surface 68 may be described as generally frustoconical i.e. generally having the shape of a cone with a tip removed.

The passage 36, specifically a radially inner portion thereof, is partially visible in FIG. 4b. The generally annular plate member 46, which obscures the plurality of vanes from view, is also visible in FIG. 4b.

The flange 54 is the connection portion by which the compressor cover 8 connects to a support member (not shown). A circumferential array of bores (two of which are labelled 70a, 70b) are also provided around the flange 54. In use, said bores 70a, 70b are configured to receive fasteners like that shown in FIG. 1 and labelled 58. When tightened, the fasteners secure the compressor cover 8 to the support member 14. In other embodiments, the compressor cover 8 may be secured to the support member 14 using a V-band clamp, bevelled circlip or other retention means.

FIG. 4c is a side view of the compressor cover 8, and other components (not visible in the FIG. 4c view) taken normal to the outlet 60. FIG. 4c illustrates how the one or more vanes 42 extend across the channel 36 defined between the first and second walls 38, 40.

Turning to FIG. 5, a cross-section view of the compressor cover 8, and other components, is illustrated. This view corresponds with the view of the compressor shown in FIG. 1, but with the compressor wheel omitted.

The wheel cavity 50 is defined at least in part by the arcuate wall surface 68. FIG. 5 also shows a plurality of vanes which extend across the passage 36. First and second vanes are labelled 42 and 43 and are generally provided at diametrically opposed positions within the passage 36. A number of other vanes are also present in FIG. 5, and their arrangement is displayed in an alternative view in the following figures.

FIG. 5 also shows the gap 41 provided between the second wall 40/plate member 46 (specifically the radially outer end 40b thereof) and the adjacent face 33a of the volute wall 33. As mentioned above, said adjacent face 33a is provided at a free end of the volute wall 33. The gap 41 is generally radial and facilitates the thermal expansion of the vanes 42 and/or plate member 46 and/or volute wall 33 relative to one another (in use).

FIG. 6a is a perspective side view of a cross section of the compressor cover 8. As will be appreciated from FIG. 6a, the cross section is taken about a plane normal to the axis 18, partway through the vanes 42, 43, 45a-g of the plurality of vanes, and facing towards the first wall 38.

FIG. 6a illustrates the circumferential distribution of vanes. The plurality of vanes comprises the first and second vanes 42, 43 and other interposing vanes 45a-c, 45d-g. The plurality of vanes all share the same geometry. That is to say, other than for the changing circumferential position about the axis 18, each of the plurality of vanes has the same thickness, shape, angle of attack etc. However, in other embodiments the vanes may have different geometries. Similarly, in other embodiments the number of vanes may be different.

Each of the vanes extends between the first wall 38 and the second wall 40 (not visible in FIG. 6a). Each of the plurality of vanes extends across the passage at least partly defined between the first and second walls 38, 40. Each of the plurality of vanes has a leading edge disposed at a common radial position relative to the axis 18. Similarly, each of the plurality of vanes has a trailing edge disposed at a common radial position relative to the axis 18. In other words, the leading and trailing edges of the vanes all lie on a circumference of two different circles.

As previously discussed, in use fluid passes through the inlet 30 and along the inlet passageway 34. Work is then done on the fluid by the compressor wheel (not shown) which is disposed in a wheel cavity 50 defined at least in part by arcuate wall surface 68. The fluid leaves the compressor wheel in a generally radial direction through the passage 36. The fluid is directed through the passage 36 along the vanes of the plurality of vanes. The velocity of the fluid is reduced, and the total pressure decreases whilst the static pressure increases (i.e. static pressure is recovered from the flow). The passage of the flow along the vanes also directs the flow tangentially in a direction more closely aligned with the volute 32. The flow then enters volute 32, passing circumferentially therethrough, and exits the compressor by the downstream outlet 60. Whilst traversing the volute 32, the increasing cross section of the volute 32 reduces the flow speed and increases the pressure (i.e. pressure is recovered from the flow). As will be appreciated by comparing FIG. 6a with FIG. 4b, the plate member 46 obscures the plurality of vanes from view and effectively closes the passage 36.

FIG. 6b is an end-on view of the cross section shown in FIG. 6a. Again, FIG. 6b shows the circumferential distribution of the plurality of vanes about central axis 18. The generally annular first wall 38 geometry is also visible in FIG. 6b. FIG. 6b also indicates how the arcuate wall surface 68 meets the first wall 38 to form a continuous surface.

The compressor cover 8 also defines a tongue 73. The tongue 73 defines a circumferential starting position of the volute 32. That is to say, from the view of FIG. 6b, flow which passes above a tip of the tongue 73 is directed towards outlet 60. Flow which passes below a tip of the tongue 73 is directed around, and through, the volute 32, around the central axis 18.

As will be appreciated from FIG. 6b, the adjacent vane 45g is angled towards the tongue 73. That is to say, fluid passing along the suction side of the vane 45g is generally directed over the tip of the tongue 73 and towards the outlet 60. Fluid which passes underneath the tongue 73, as illustrated in FIG. 6b, may be said to ‘drive’ the volute 32 in that the fluid may create a pressure drop across a comparatively narrow section of the volute 32.

Turning to FIG. 7a, a cross section like that of FIG. 6a is provided, but FIG. 7a is taken in a direction facing the second wall 40. Many of the features in FIG. 7a are similar to those as shown in FIGS. 6a and 6b and will therefore not be described in detail.

FIG. 7a illustrates how the radially outer end 40b of the second wall 40 partly defines the volute 32. That is to say, the passage 36 opens out into the volute 36. It will also be appreciated that the volute wall 33, which defines the volute 32, extends from the first wall 38 but does not connect to/merge with the second wall 40 (owing to the gap 41 provided between a free end of the volute wall 33 and the second wall 40). The volute wall 33 is a generally U-shaped wall. In embodiments not incorporating the gap 41, the volute wall may connect the first and second walls 38, 40 (specifically radially outer ends 38b, 40 thereof). The volute wall 33 is generally circular in cross-section (and toroidal in three dimensions) and may be described as kidney-bean-shaped, owing to the varying geometry of the cross section of the volute 32.

Ends of the vanes 42, 43, 45a-g which are adjacent the second wall 40 incorporate filleted edges. This may be in contrast to ends of the vanes 42, 43, 45a-g which are adjacent the first wall 38, which may not be filleted. In some embodiments both ends of the vanes 42, 43, 45a-g may be filleted. It may be desirable to reduce the fillets to as small a radius as is possible to manufacture.

The vanes 42, 43, 45a-g may be tapered along their length. A thickness (i.e. a generally radial extent) of the vanes 42, 43, 45a-g may be lower at a radially inner portion of the vane, in comparison to a comparatively greater thickness at a radially outer portion of the vane. A suction side of the vanes, labelled 45e′ for the vane 45e, may comprise a plurality of portions. The suction side may comprise an arcuate portion and a linear portion. In other embodiments, a thickness of the vanes may be greater at a radially inner portion of the vane, in comparison to a comparatively lower thickness at a radially outer portion of the vane. Such vanes may be referred to as ‘fore thickened vanes’.

As indicated in FIGS. 6a-7b, the plurality of vanes are solid along their axial extent (i.e. effectively filled with material between the pressure side and suction side). However, in other embodiments the one or more of the vanes may be hollow. The one or more vanes may have one or more cavities between the pressure and suction side of the vanes. One or more ribs may be provided within the one or more cavities. Hollow vanes may be advantageous for reasons of material saving and improved thermal performance.

FIGS. 7a and 7b also illustrate how the second wall 40 is uninterrupted save for the plurality of vanes. That is to say, the surface does not incorporate any apertures (e.g. for bolts) or other surface recesses or projections, save for the one or more vanes. This is advantageous in removing the need for such features in attaching the vanes where the vanes form part of a component which is separate to the compressor cover.

A compressor wheel bore 71 is also shown in FIG. 7b. During assembly, the compressor cover 8 is placed over a compressor wheel mounted to a shaft in-situ. The compressor wheel passes through the wheel bore 71. The wheel bore 71 may have a diameter equal to between around 1.01× and around 1.05× the compressor wheel outer diameter.

FIG. 8 shows a compressor cover 108, among other components, in accordance with a further embodiment. Many other components are the same as in FIG. 5, and will therefore not be described in detail.

In the FIG. 8 embodiment, the arcuate wall surface 68 is not an integral part of the compressor cover 8. Instead, the arcuate wall surface 68 is provided on an insert 69. The insert 69 is mounted within the inlet passageway 34 to define the wheel cavity 50. The radially outermost geometry of the insert 69 geometry corresponds with the lines indicated in FIG. 5, and labelled 69a, b. As such, the insert 69 generally has a frustoconical geometry. Also in the FIG. 8 embodiment, the second wall 40 forms part of an integral support member 114 (only part of which is shown, as indicated by the wavy line). The support member 114 provides at least the same functionality as the seal plate, and may also provide the functionality of a bearing housing. That is to say, the support member 114 may connect to a separate bearing housing or, alternatively, may constitute at least part of a bearing housing.

During assembly, the insert 69 is inserted through the inlet 30, and passed along the inlet passageway 34. The insert 69 is then mounted within the inlet passageway 34. This advantageously means that the wall surface 68 can conform closely to an external geometry of the compressor wheel even when the second wall member 40 forms part of the integral support member 114 (e.g. a seal plate or bearing housing). As such, an assembly process for the FIG. 8 embodiment includes inserting the compressor wheel through the inlet 30, and along the inlet passageway 34, and securing the compressor wheel to the shaft. The insert 69 is then inserted through the inlet 30, and passed along the inlet passageway 34. The insert 69 is then mounted within the inlet passageway 34 to define the wheel cavity 50. This is in contrast to prior art arrangements in which the compressor cover is placed over the compressor wheel, when the compressor wheel is secured to the shaft. Further inlet components, such as a cup, are then inserted once the insert is mounted in place.

The insert may be mounted within the inlet passageway by a mechanical fastening means, such as a bolt; an integral fastening means, such as a screw thread; welds or piston rings, to name some examples. The insert may alternatively be press-fitted into the inlet passageway. Each of the insert 69 and inlet passageway 34 may comprise a connection portion. Respective connection portions may engage one another, directly or indirectly, to mount the insert 69 within the inlet passageway 34.

The compressor cover disclosed herein may form part of a compressor. The compressor may form part of a turbocharger. The turbocharger may form part of an engine arrangement, such as an automobile or a generator. The compressor cover disclosed herein may alternatively form part of a supercharger, such as a centrifugal supercharger.

In use, the compressor may reach temperatures of up to between around 300°-320° C.

A seal plate, or diffuser plate, may be incorporated where the compressor cover forms part of a high horsepower turbocharger. For example, where the horsepower is in excess of around: 750 kW (˜1000 HP). In lower horsepower variants, the seal plate, or diffuser plate, may be omitted and the compressor cover may directly engage a bearing housing.

The compressor cover may provide a mounting point by which the compressor can be mounted in an assembly.

It may be desirable to incorporate diffuser vanes in compressors forming part of larger size turbochargers e.g. turbochargers incorporating a compressor having a compressor impeller (or wheel) with a diameter of at least around 100 mm, and optionally less than around 200 mm.

Examples according to the disclosure may be formed using an additive manufacturing process. A common example of additive manufacturing is 3D printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modeling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes. Binder Jetting has been found to be particularly effective for manufacturing the components disclosed herein.

The additive manufacturing processes described herein may be used for forming components using any suitable material. For example, the material may be plastic, metal, composite, concrete, ceramic, polymer, epoxy, photopolymer resin, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in additive manufacturing processes which may be suitable for the fabrication of examples described herein. Stainless steel, in particular grade AISI 316L, is a preferred material for use in manufacturing the components disclosed herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on three-dimensional (3D) information, for example a three-dimensional computer model (or design file), of the component.

Accordingly, examples described herein not only include products or components as described herein, but also methods of manufacturing such products or components via additive manufacturing and computer software, firmware or hardware for controlling the manufacture of such products via additive manufacturing.

The structure of one or more parts of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus can be instructed to print out one or more parts of the product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

The described and illustrated embodiments are to be considered as illustrative and not restrictive in character, it being understood that only preferred embodiments have been shown and described and that all changes and modifications that come within the scope of the inventions as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

1. A compressor cover for a turbomachine, the compressor cover defining a central axis and comprising:
an inlet in fluid communication with a downstream outlet via a passage; wherein
the passage is at least partly defined between a first wall and a second wall of the compressor cover; and wherein
one or more vanes extend across the passage, between the first and second walls, the one or more vanes being integrally formed with the first and second walls.

2. The compressor cover according to claim 1, wherein the one or more vanes comprises a plurality of vanes.

3. The compressor cover according to claim 2, wherein the plurality of vanes are circumferentially distributed about the central axis.

4. The compressor cover according to claim 1, wherein each of the one or more vanes extends across the passage, between the first and second walls.

5. (canceled)

6. The compressor cover according to claim, 1 wherein the second wall forms part of a plate member.

7. The compressor cover according to claim 6, wherein the plate member is annular.

8. (canceled)

9. The compressor cover according to claim 1, wherein the second wall is uninterrupted save for the one or more vanes.

10. The compressor cover according to claim 1, wherein the first and second walls are substantially parallel.

11. The compressor cover according to claim 1, wherein radially outer ends of the first and second walls at least partly define a scroll.

12. The compressor cover according to claim 11, wherein the passage is in fluid communication with the downstream outlet via the scroll.

13. The compressor cover according to claim 11, wherein a gap is provided between the radially outer end of the second wall and an adjacent face of a volute wall.

14. The compressor cover according to claim 1, wherein the compressor cover is a centrifugal compressor cover.

15. The compressor cover according to claim 1, wherein the inlet is an axial inlet.

16. The compressor cover according to claim 15, wherein the axial inlet defines an inlet passageway sized to allow passage of a compressor wheel.

17. The compressor cover according to claim 16, wherein the inlet passageway is configured to receive an insert.

18. A compressor assembly comprising the compressor cover according to claim 17, and further comprising:
an insert mounted within the inlet passageway; wherein
the second wall of the compressor cover forms part of a support member; and wherein
the support member and insert cooperate to define a wheel cavity configured to receive a compressor wheel.

19. The compressor cover according to claim 1, further comprising a connection portion configured to engage a corresponding connection portion of a support member.

20. A compressor comprising the compressor cover according to claim 1.

21. A turbomachine comprising the compressor according to claim 20.

22. A method of manufacturing a compressor cover using an additive manufacture method.

23. A method of assembling a compressor, the compressor comprising:
a compressor cover defining a central axis and comprising an inlet in fluid communication with a downstream outlet, the compressor cover being integrally formed with a support member;
a shaft which extends through the support member; and
a compressor wheel;
the method comprising the steps of:
(i) inserting the compressor wheel through the inlet and along an inlet passageway;
(ii) securing the compressor wheel to the shaft; and
(iii) inserting the insert through the inlet, and along the inlet passageway, and mounting the insert within the inlet passageway to define a wheel cavity.

24. A computer program comprising computer executable instructions that, when executed by a processor, cause the processor to control an additive manufacturing apparatus to manufacture a compressor cover.

25. A method of manufacturing a compressor cover according to claim 22, the method comprising:
obtaining an electronic file representing a geometry of a product wherein the product is a compressor cover; and
controlling an additive manufacturing apparatus to manufacture, over one or more additive manufacturing steps, the product according to the geometry specified in the electronic file.
